(19) United States
(12) Patent Application Publication
(10) Pub. No.: US 2014/0278477 A1
(43) Pub. Date: Sep. 18, 2014

(54) ARCHITECTURE FOR ORCHESTRATING THE ELECTRONIC EXECUTION OF ACKNOWLEDGEMENT OF CONTENT (AOC)

(71) Applicant: J. KNIPPER AND COMPANY, Lakewood, NJ (US)

(72) Inventors: Joseph C. Schmadel, JR., Mendham, NJ (US); Stephen S. Gransden, Chesterfield, NJ (US)

(21) Appl. No.: 13/871,600

(22) Filed: Apr. 26, 2013

Related U.S. Application Data
(60) Provisional application No. 61/778,780, filed on Mar. 13, 2013.

(51) Int. Cl. G06Q 50/22; G06Q 30/00

(52) U.S. Cl. CPC G06Q 50/22; G06Q 30/018
USPC 705/2

(57) ABSTRACT

A system and method for orchestrating electronic execution of acknowledgment of content includes a service engine that generates at least a first type of data and a second type of data in response to at least one sample request order that is processed and validated. The system and method include a compliance engine that receives and stores the first type of data and the second type of data from the service engine. The system and method include an orchestration engine that verifies the first type of data and forwards an electronic proof of acknowledgement through an interface to the compliance engine such that the electronic proof is appended to both the first type of data and the second type of data.

### PRIORITY INFORMATION

This application claims priority from provisional application Ser. No. 61/778,780 filed Mar. 13, 2013, which is incorporated herein by reference in its entirety.

### FIELD OF THE INVENTION

The present invention relates generally to architecture for orchestrating the electronic execution of acknowledgement of content of drug sample distributions, and more particularly, to the design of software related to acknowledgement of content execution incorporating protocols and means for expansion and interfacing with other systems.

### BACKGROUND OF THE INVENTION

Once the Food and Drug Administration (FDA) has approved a drug, a pharmaceutical company promotes the drug in a number of ways, including the use of sales representatives and non-personal or self-service methods. In either case, it is often the practice of the pharmaceutical company to provide prescribers access to drug samples in the hope that the prescribers will prescribe these drugs to their patients.

In response to the Prescription Drug Marketing Act of 1987, and in an attempt to identify potential diversion of drug samples, pharmaceutical companies employ a method of verification, most commonly, but not exclusively, known as “Acknowledgement of Content” (AOC) to ensure that drug samples shipped directly to a prescriber are received, in their entirety, as stated on the packing slip or manifest which accompanies the sample shipment. Traditionally, a paper-based AOC form is provided with each shipment of samples to the prescriber. The form contains a detailed breakdown of itemized product information which can be matched to each item in the shipment. Upon unpacking of the shipment, the prescriber (or a designee of the prescriber) must verify that the drug sample items contained in the shipment match all items listed on the AOC form, sign the form, then return the form to the pharmaceutical company or their distributer to maintain a compliance record of the sample shipment. The form is then scanned or keyed into a system which stores the compliance data for a period of time designated by the pharmaceutical company.

It is a common practice of most pharmaceutical companies to restrict samples to prescribers who have not provided all acknowledgements of content forms for a specified period of time as this creates compliance risk for the pharmaceutical company. Ensuring compliance by prescribers is often difficult and expensive due to the inconvenience of traditional paper-based mail and fax processes and the time-consuming nature of forms entry by the pharmaceutical company or distributer's personnel. In addition to process cost and inefficiency, non-compliance (or the inherent delay in paper-based cycle times) which result in the pharmaceutical company's inability to provide additional samples, significantly reduces the returns which are associated with subsequent scripts generated after successful patient titration through the drug sample process. Thus, there exists the need for an architecture which orchestrates acknowledgement of content while avoiding or reducing the foregoing and other problems.

### SUMMARY OF THE INVENTION

According to one aspect of the invention, there is provided a system for orchestrating electronic execution of acknowledgment of content. The system includes a service engine that generates at least a first type of data and a second type of data in response to at least one sample request order that is processed and validated. The system includes a compliance engine that receives and stores the first type of data and the second type of data from the service engine. The system includes an orchestration engine that verifies the first type of data and forwards an electronic proof of acknowledgement through an interface to the compliance engine such that the electronic proof is appended to both the first type of data and the second type of data.

According to another aspect of the invention, there is provided a method for orchestrating electronic execution of acknowledgment of content. The method includes the step of generating at least a first type of data and a second type of data by a service engine in response to at least one sample request order that is processed and validated. The method includes the step of receiving and storing the first type of data and the second type of data from the service engine in a compliance engine. The method includes the step of verifying the first type of data by an orchestration engine and forwarding an electronic proof of acknowledgement through an interface to the compliance engine such that the electronic proof is appended to both the first type of data and the second type of data.

### BRIEF DESCRIPTION OF THE DRAWINGS

FIG. 1 is a block diagram that illustrates different components and data flow directions of the electronic AOC management process life cycle;

FIG. 2 is a process diagram that illustrates relationships between system components;

FIG. 3 is a block diagram that illustrates different components of the system for interacting with the orchestration engine;

FIG. 4 is a process diagram that illustrates the electronic orchestration of AOC; and

FIG. 5 is a process diagram that illustrates a method for orchestrating electronic AOCs.

### DETAILED DESCRIPTION OF THE INVENTION

The invention involves a services engine that provides transactional responses to a user's requests, directly correlated to unique key data generated by the service engine that corresponds to the acknowledgement of content (AOC) compliance record of a specific shipment, with resulting compliance information being returned to the user's computer or electronic device for verification by the user and subsequent return of proof of acknowledgement of the compliance information's legitimacy and accuracy. The compliance engine stores key data previously generated by the service engine and maintains compliance detail information with respect to matching shipments and, upon receipt of the unique key from the orchestration engine, provides the matching compliance detail information to the orchestration engine for electronic delivery to the user interface. Upon receipt of proof of acknowledgement via the orchestration engine, the compliance engine appends the acknowledgement of content (AOC) compliance record with the proof of acknowledgment data received.

FIG. 1 illustrates different components and the data flow directions of the electronic AOC management process life cycle. As later described in further detail, a service engine 101 comprises an order processing system (OPS) 105 and a warehouse management system (WMS) 106. The OPS 105 processes any and all sample request orders received based on the order validation rules which are set uniquely at the customer job level. For every order that is received, the OPS 105 generates a unique key data and transfers this data to a compliance engine 102. After successful completion of validation, the OPS 105 transfers the order data to the WMS 106 for shipping. The shipment details are sent by the WMS 106 to the OPS 105, which again get transferred to the compliance engine 102.

As later described in further detail, the compliance engine 102 comprises a compliance data processing system (CDPS) 109 and AOC master 110. The compliance engine 102 stores AOC information received from the service engine 101, and upon receiving the unique key data from the orchestration engine 103, provides matching compliant AOC information to the orchestration engine 103. The CDPS 109 is the part of compliance engine 102 which interacts with the service engine 101, whereas the AOC master 110 interacts with the orchestration engine 103. Upon receiving the proof of receipt from the user via the orchestration engine 103, the AOC master 110 appends the proof of acknowledgement (POA) to the original compliance information.

The orchestration engine 103 provides user interface 112 functionality such as receiving the AOC information requests (unique key data) from the user and displaying the requested compliance AOC information through the user interface 112, upon gathering the information from the compliance engine 102. The proof of acknowledgement that the user returns after verifying the AOC information is forwarded by the orchestration engine 103 to the compliance engine 102. The orchestration engine 103 acts as a bridge between the user and the compliance engine 102, where all the compliance AOC information is stored.

As shown in FIG. 2, the architecture for orchestrating the electronic execution of acknowledgement of content (AOC) consists of a service engine 101, compliance engine 102 and an orchestration engine 103. The service engine 101 comprises an order processing system (OPS) 105 which manages order processing/validation, and a warehouse management system (WMS) 106 which manages order fulfillment. Upon receiving a sample request order 104, the order 104 is transferred to the OPS 105 for processing/validation of the order. The order 104 is validated using a set of order validation rules, which are configurable per client requirements and compliance laws. The order 104 is processed by the OPS 105 and is then transferred to the WMS 106 for verification of the inventory followed by pick/pack/ship for order fulfillment. For each shipment 107 that is processed by the WMS 106, associated shipment data is sent back to the OPS 105 which is transferred to the compliance data processing system (CDPS) 109, in the compliance engine 102, along with a unique key data related to that particular order generated by the OPS 105. This shipment data and the unique key data of that particular order are transferred from CDPS 109 to the AOC master 110, in the compliance engine 102, where the AOC record is stored.

The order fulfillment shipment 107 is done by shipment carrier services and for each order 107 that is shipped; an acknowledgement of delivery is received from the shipping carrier upon delivery 108 of the sample fulfillment shipment/package. The AOD data of an order 108, received from the shipment carrier services is transferred by the CDPS 109 to the AOC master 110, where the AOD data gets appended to the unique key data and shipment data of the particular order, which are already stored in the AOC master 110. At this stage of the process, CDPS 109 establishes the particular shipment data as an open AOC. It is noted that the unique key data (pick slip number), shipment data and AOD data are the mandatory pre-conditions for an “open” AOC, where “open” refers to the fact that no signed acknowledgement of content has been received corresponding to the shipment referenced in the AOD data. This process of mandatory pre-conditions helps to ensure that and AOC is not prematurely considered “open” and the open AOC period is accurately reflected within the system.

Further shown in FIG. 2, the orchestration engine 103 comprises a user interface 112 and an AOC interface 111, where the AOC interface 111 acts as a medium between users and the AOC master 110, by allowing the transfer of compliant AOC information data. Once the user, through a user interface 112 (for example, a website, mobile device, etc.), requests the AOC (shipment) details regarding a particular order using the unique key data (pick slip number), the AOC interface 111 gathers the request/unique key data and transfers it to the AOC master 110. The AOC master 110 sends back the compliant AOC data which is matching to the requested unique key data, to the AOC interface 111. The compliant AOC information received from AOC master 110 is displayed to the user by the AOC interface 111, through the user interface 112. The user verifies the compliant AOC/shipment related details shown as part of AOC and sends back the proof of acknowledgement (electronically signed AOC) to the AOC interface 111. The AOC interface 111 collects the proof of acknowledgement from the user and transfers it to the AOC master 110, where the proof of acknowledgement is appended to the original AOC data (unique key data, shipment data and AOD of the particular order) and the AOC is closed.

FIG. 3 illustrates the different components of the system by which the users are coupled to the AOC orchestration ecosystem. An orchestration ecosystem 207 is used by the pharma representatives 201 (who works for pharma 204 and distributes the sample pharmaceuticals manufactured by the pharma 204 to the prescribers/designees 202 hoping that they will prescribe the pharmaceutical samples to their patients), to manage the AOC information that is associated with his/her sample transactions. The pharma representatives 201 are entitled to solicit a proof of acknowledgement for all the promotional sample shipments received by their prescribers/designees 202. The pharma representatives 201 use the orchestration ecosystem 207 to facilitate closing (providing the proof of acknowledgement) of the AOCs by the prescribers 202 or the prescriber's designee 202.

Prescribers 202 are the authorized personnel to provide drug samples to the patients/consumers. The prescribers and/or their designee 202 use the orchestration ecosystem 207 for managing the AOC information associated with their sample transactions. If the prescriber/designee 202 is directly receiving the drug samples from a distributor 203, the prescriber/designee 202 is entitled to submit a proof of acknowledgement after receiving the drug sample shipment. The prescribers/designees 202 use the orchestration ecosystem 207 to view and/or close (providing the proof of acknowledgement) the AOCs.

Pharma 204 is a company engaged in the manufacture and sales of pharmaceuticals, which are medical drugs used for therapeutic applications. Pharma 204 accesses the orchestration ecosystem 207 to view the status of AOCs. By viewing the current status of AOCs, pharma 204 analyzes the compliance of their pharma representatives 201 and prescribers/designees 202 and if necessary (number of open AOCs are above the allowed limit), pharma 204 will notify the pharma representative 201 and/or prescriber/designee 202 to close the open AOCs. If the pharma representative 201 and/or prescriber/designee 202 fails to do so, pharma 204 has the full authority to stop the prescriber/designee 202 from being sampled again. It is mandatory that all the products that are shipped/received/distributed should be accountable.

The distributor 203 manages the distribution/fulfillment of the samples that a pharma 204 manufactures. The distributor 203 keeps track of the AOC details of each prescriber/designee 202 and notifies them if it seems the sampling transactions does not meet the compliance rules. The distributor 203 will make sure that, in a case of exceeding the allowed number of open AOCs, a prescriber/designee 202 is made non-sampleable until the pharma 204 authorizes them to be sampleable again.

The pharma representatives 201, prescribers/designees 202, distributor 203 and pharma 204 access the orchestration ecosystem 207 via a plurality of input/output devices 205. These input/output devices 205 include wired/wireless workstations such as desktop computers, laptop computers, notebook computers, servers and similar hardware. Other input/output devices include personal digital assistants; personal digital assistant proxies; telephones; printers and facsimile communication machines. The input/output devices 205 are coupled to the AOC orchestration ecosystem 207 via a network 206.

The network 206 comprises a group of computers and associated devices that are connected by communication facilities. The network 206 may involve permanent connections, such as coaxial or other cables, or temporary connections made through telephone or other communication links. The network 206 may be as small as LAN (Local Area Network) consisting of a few computers, printers and other devices, or many small and large computers distributed over a vast geographical area (WAN or Wide Area Network). The Internet is a very good example of WAN, which is a worldwide connection of networks and gateways.

The orchestration ecosystem 207 collects the requests (unique key data) from the users (pharma representatives 201, prescribers/designees 202, distributor 203 and pharma 204) and displays the matching compliance information through the input/output devices 205.

Referring now to FIG. 4, this illustrates a method for orchestration of a drug sample shipment with acknowledgement of content. For purposes of clarity, the following description of this method 400 makes references to various elements illustrated in connection of electronic AOC management orchestration of FIG. 2. From a start block 400, the method proceeds to a step 401, defined between a continuation terminal (“terminal A”) and an exit terminal (“terminal B”), and that initially, a user requests to start a method of orchestration, such as acknowledging a closure of the order. From terminal A, the method proceeds to step 401 where the user requests to receive compliance detail information regarding a unique shipment of samples using a previously generated unique key as a quick response code generated by the service engine 101 and scanned by a user's mobile device. The method then enters the exit terminal B.

From exit terminal B, the method proceeds to another step 402, defined between a continuation terminal (“terminal C”) and an exit terminal (“terminal D”), where communication between the orchestration engine 103 and compliance engine 102 is referenced. From terminal C, the unique key data is passed on to the compliance engine 102 for matching a corresponding acknowledgement of content (AOC) compliance record, and returns the corresponding AOC compliance information provided by the compliance engine 102 to the user. The method then exits proceeds to exit terminal D.

Once the device receives this information, it is displayed on the screen for the user to verify. From exit terminal D, the method proceeds to a step 403, defined between a continuation terminal (“terminal E”) and an exit terminal (“terminal F”) where communication between the orchestration engine 103 and the compliance engine 102 for the closure of AOC is referenced. From terminal E, upon verification of legitimacy and accuracy of the compliance information, the user provides proof of acknowledgement (for example, a digital signature, mouse signature, etc.) captured on the user's device, and is transferred by the orchestration engine 103 to the compliance engine 102 which appends the referenced AOC record with the AOC compliance data received. The method then exits from terminal F, where it terminates execution 404.

FIG. 5 defines the steps involved in the electronic AOC management process life cycle and orchestration method. The user, through the user interface 112 and starting from 500, makes a call 501 requesting the AOC information using the unique key data. This unique key data is transmitted to the AOC interface 111. The AOC interface 111 receives 502 the unique key data and transfers 503 it to the AOC master 110. The AOC master 110 receives 504 the unique data and collects 505 the compliance AOC information associated/matching to the unique key data. The compliance AOC information associated information is transferred 506 from the AOC master 110 to the AOC interface 111. The AOC interface 111 receives 507 and transfers 508 the same to the user interface 112 where it is displayed 509 to the user.

The user, upon verification 510 of the compliance AOC information being displayed through the user interface 112, acknowledges 511 the AOC information and sends back a proof of acknowledgement (POA) to the AOC interface 111 through the user interface 112. The AOC interface 111 receives 512 and transfers 513 the POA to the AOC master 110. Upon receiving 514 the POA, the AOC master 110 appends 515 the POA to the original AOC information and the AOC is closed 516 and saved and then terminated 517.

Although the present invention has been shown and described with respect to several preferred embodiments thereof, various changes, omissions and additions to the form and detail thereof, may be made therein, without departing from the spirit and scope of the invention.

What is claimed is:

1. A system for orchestrating electronic execution of acknowledgment of content, comprising:
a service engine that generates at least a first type of data and a second type of data in response to at least one sample request order that is processed and validated;
a compliance engine that receives and stores said first type of data and said second type of data from said service engine; and
an orchestration engine that verifies said first type of data and forwards an electronic proof of acknowledgement through an interface to said compliance engine such that said electronic proof is appended to both said first type of data and said second type of data.

2. The system of claim 1, wherein said first type of data comprises unique key data of said order and said second type of data comprises said shipment data of said order.

3. The system of claim 1, wherein said service engine comprises an order processing system that processes sample request orders based on a set order of validation rules.

4. The system of claim 3, wherein said service engine comprises a warehouse management system that sends said second type of data to said order processing system, said order processing system transfers said second type of data to said compliance engine.

5. The system of claim 1, wherein said compliance engine comprises a compliance data processing system that receives said first type of data and said second type of data from said service engine.

6. The system of claim 5, wherein said compliance engine comprises an acknowledgment of content master system that receives said first type of data and said second type of data from said compliance data processing system.

7. The system of claim 6, wherein said acknowledgment of content master system collects compliant acknowledgment of content information matching to said first type of data.

8. The system of claim 7, wherein said orchestration engine comprises an acknowledgment of content interface that allows transfer of said compliant acknowledgment of content information from said acknowledgment of content master system.

9. The system of claim 1, wherein said electronic proof of acknowledgment comprises a digital signature or a mouse signature.

10. The system of claim 1, further comprising an orchestration ecosystem that collects at least said first type of data from a plurality of users and displays matching compliance information through a plurality of input and output devices.

11. A method for orchestrating electronic execution of acknowledgment of content, comprising the steps of:
generating at least a first type of data and a second type of data by a service engine in response to at least one sample request order that is processed and validated;
receiving and storing said first type of data and said second type of data from said service engine in a compliance engine; and
verifying said first type of data by an orchestration engine and forwarding an electronic proof of acknowledgement through an interface to said compliance engine such that said electronic proof is appended to both said first type of data and said second type of data.

12. The method of claim 11, wherein said first type of data comprises unique key data of said order and said second type of data comprises said shipment data of said order.

13. The method of claim 11, wherein said service engine comprises an order processing system that processes sample request orders based on a set order of validation rules.

14. The method of claim 13, wherein said service engine comprises a warehouse management system that sends said second type of data to said order processing system, said order processing system transfers said second type of data to said compliance engine.

15. The method of claim 11, wherein said compliance engine comprises a compliance data processing system that receives said first type of data and said second type of data from said service engine.

16. The method of claim 15, wherein said compliance engine comprises an acknowledgment of content master system that receives said first type of data and said second type of data from said compliance data processing system.

17. The method of claim 16, wherein said acknowledgment of content master system also collects compliant acknowledgment of content information matching to said first type of data.

18. The method of claim 17, wherein said orchestration engine comprises an acknowledgment of content interface that allows transfer of said compliant acknowledgment of content information from said acknowledgment of content master system.

19. The method of claim 11, wherein said electronic proof of acknowledgment comprises a digital signature or a mouse signature.

20. The method of claim 11, further comprising the step of collecting at least said first type of data by an orchestration ecosystem from a plurality of users and displaying matching compliance information through a plurality of input and output devices.
